(19) United States
(12) Patent Application Publication
(10) Pub. No.: US 2026/0038089 A1
(43) Pub. Date: Feb. 5, 2026

(54) IMAGE PROCESSING DEVICE AND METHOD

(71) Applicant: SK hynix Inc., Icheon-si (KR)

(72) Inventor: Takuya KOTANI, Tokyo (JP)

(21) Appl. No.: 19/287,656

(22) Filed: Jul. 31, 2025

(30) Foreign Application Priority Data
Jul. 31, 2024 (KR) 10-2024-0102054

(51) Int. Cl. G06T 5/50

(52) U.S. Cl. CPC G06T 5/50; G06T 2207/10024; G06T 2207/10144

(57) ABSTRACT

In an embodiment, an image processing device includes a determiner and an image synthesizer. The determiner is configured to detect an image difference between a plurality of images including a first image captured during a first exposure time and a second image captured during a second exposure time shorter than the first exposure time, and to determine whether the image difference corresponds to a flicker or a moving object. Upon determining that the image difference corresponds to the flicker, the image synthesizer synthesizes the plurality of images by assigning a highest weight to the first image among a plurality of weights respectively assigned to the plurality of images. Upon determining that the image difference corresponds to the moving object, the image synthesizer synthesizes the plurality of images by assigning the highest weight to the second image among the plurality of weights respectively assigned to the plurality of images.

### APPLICATION

This patent document claims the priority and benefits of Korean patent application No. 10-2024-0102054, filed on Jul. 31, 2024, the disclosure of which is incorporated herein by reference in its entirety as part of the disclosure of this patent document.

### TECHNICAL FIELD

The technology and implementations disclosed in this patent document generally relate to an image processing device and an image processing method.

### BACKGROUND

An image sensing device captures optical images by converting light into electrical signals using a photosensitive semiconductor material that reacts to light. With advancements in industries such as automotive, medical, computer and communication industries, the demand for high-performance image sensing devices is growing across various fields such as smartphones, digital cameras, game machines, IoT (Internet of Things), robots, security cameras and medical micro cameras.

Images captured by the image sensing device may vary depending on exposure time, gain, and other settings, and may also exhibit image distortion due to flicker or similar phenomena.

### SUMMARY

Various embodiments of the disclosed technology relate to an image processing device that synthesizes a plurality of images in which flicker or a moving object is present.

Various embodiments of the disclosed technology relate to an image processing device that determines whether flicker or a moving object is present based on luminance values of pixels to be synthesized.

Various embodiments of the disclosed technology relate to an image processing device that adjusts the weights used in image synthesis depending on the presence of flicker or a moving object.

Various embodiments of the disclosed technology relate to an image processing device that corrects a color of an image using a white balance coefficient before image synthesis in order to prevent color distortion of a composite image.

In an embodiment of the disclosed technology, an image processing device may include a determiner configured to detect an image difference between a plurality of images of a scene including a first image captured during a first exposure time and a second image captured during a second exposure time shorter than the first exposure time, wherein the image difference is related to various factors including occurrence of a flicker or motion of an object in the scene. When the image difference corresponds to the flicker, the image synthesizer synthesizes the plurality of images by assigning a highest weight to the first image among a plurality of weights respectively assigned to the plurality of images. When the image difference corresponds to the motion of the object, the image synthesizer synthesizes the plurality of images by assigning the highest weight to the second image among the plurality of weights respectively assigned to the plurality of images. In some implementations, the flicker is defined as a temporal luminance fluctuation occurring in a stationary region due to a periodic light source.

In some implementations, the determiner may be configured to determine that the image difference corresponds to the flicker, in response to determining that a ratio of the number of pixels each having a luminance value equal to or less than a threshold luminance value among synthesis target pixels to the number of the synthesis target pixels located at a same position within the plurality of images is less than a threshold ratio, and determine that the image difference corresponds to the motion of the object, in response to determining that the ratio is greater than or equal to the threshold ratio.

In some implementations, the determiner may be configured to: determine the threshold luminance value based on an average value of luminance values of pixels that have a same color as a first synthesis target pixel in a predetermined region including the first synthesis target pixel within the first image.

In some implementations, the plurality of images may include: a third image captured during a third exposure time that is shorter than the first exposure time and longer than the second exposure time, wherein the determiner determines that the image difference corresponds to the flicker upon determining that luminance reduction has occurred in at least one of the second image and the third image.

In some implementations, the plurality of images may include: a third image captured during a third exposure time that is shorter than the first exposure time and longer than the second exposure time, wherein the determiner determines that the image difference corresponds to the motion of the object upon determining that luminance reduction has occurred in the second image and the third image.

In some implementations, the image processing device may further include: a color corrector configured to correct a color of the first image by: correcting a first red component value of the first image using a first white balance coefficient; and correcting a first blue component value of the first image using a second white balance coefficient.

In some implementations, the color corrector is configured to correct a color of the first image by: generating a second red component value by multiplying the first red component value by the first white balance coefficient; generating a third red component value by dividing a smaller first value between the second red component value and a green component saturation value by the first white balance coefficient; replacing the first red component value of the first image with the third red component value; generating a second blue component value by multiplying the first blue component value by the second white balance coefficient; generating a third blue component value by dividing a smaller second value between the second blue component value and the green component saturation value by the second white balance coefficient; and replacing the first blue component value of the first image with the third blue component value.

In some implementations, the color corrector may be configured to correct the color of the first image to generate a color-corrected first image, upon determining that the image difference corresponds to the flicker; and the image synthesizer may be configured to synthesize the plurality of images using the color-corrected first image.

In some implementations, the determiner may be configured to: determine that neither the flicker nor the motion of the object has occurred in response to determining that a difference between a largest pixel value and a smallest pixel value among pixel values of synthesis target pixels located at a same position in the plurality of images is less than a threshold difference value.

In some implementations, the image synthesizer may be configured to: synthesize the plurality of images by adjusting the plurality of weights according to a luminance value of any one of the plurality of images upon determining that neither the flicker nor the motion of the object has occurred.

In some implementations, the image synthesizer may be configured to: generate a composite image by using a pixel value of the first pixel when a luminance value of a first pixel of the first image is less than a first threshold luminance value; generate a composite image by combining, at a predetermined ratio, (i) a pixel value of a second pixel located at the same position as the first pixel in the second image and (ii) the pixel value of the first pixel, in response to the luminance value of the first pixel being equal to or greater than the first threshold luminance value and less than a second threshold luminance value; and generate the composite image using the pixel value of the second pixel in response to the luminance value of the first pixel being equal to or greater than the second threshold luminance value.

In some implementations, the predetermined ratio may linearly change as the luminance value of the first pixel increases from the first threshold luminance value to the second threshold luminance value.

In some implementations, the image processing device may further include: a gain controller configured to: generate the first image by correcting a first input image using a first gain; and generate the second image by correcting a second input image using a second gain greater than the first gain.

In some implementations, the gain controller may be configured to: determine a ratio of the first gain to the second gain as an inverse of a ratio of the first exposure time to the second exposure time.

In another embodiment of the disclosed technology, an image processing device may include: a determiner configured to determine whether a ratio of the number of pixels having a luminance value less than or equal to a threshold luminance value among synthesis target pixels to the number of the synthesis target pixels located at a same position in a plurality of images is less than a threshold ratio; and an image synthesizer configured to perform image synthesis by adjusting a plurality of weights for each of the synthesis target pixels based on a result of the determination.

In some implementations, the plurality of images may include a first image captured during a longest exposure time among the plurality of images; and the image synthesizer may be configured to perform image synthesis by assigning a highest weight to the first image among the plurality of weights respectively assigned to the plurality of images in response to the ratio being less than the threshold ratio.

In some implementations, the plurality of images may include a second image captured during a shortest exposure time among the plurality of images; and the image synthesizer may be configured to perform image synthesis by assigning a highest weight to the second image among the plurality of weights respectively assigned to the plurality of images in response to the ratio being greater than or equal to the threshold ratio.

In some implementations, the plurality of images may include a first image captured during a longest exposure time among the plurality of images. The image processing device may further include: a color corrector configured to correct a color of the first image by: correcting a first red component value of the first image using a first white balance coefficient; and correcting a first blue component value of the first image using a second white balance coefficient.

In some implementations, the color corrector may be configured to correct a color of the first image by: generating a second red component value by multiplying the first red component value by the first white balance coefficient, generating a third red component value by dividing a smaller first value between the second red component value and a green component saturation value by the first white balance coefficient, and replacing the first red component value of the first image with the third red component value; and generating a second blue component value by multiplying the first blue component value by the second white balance coefficient, generating a third blue component value by dividing a smaller second value between the second blue component value and the green component saturation value by the second white balance coefficient, and replacing the first blue component value of the first image with the third blue component value.

In another embodiment of the disclosed technology, an image processing method may include: determining whether there is an image difference between a plurality of images of a scene based on luminance values of synthesis target pixels located at a same position in the plurality of images, wherein the image difference includes at least one of an image difference corresponding to flicker or an image difference corresponding to a motion of an object of the scene; and performing image synthesis by adjusting a plurality of weights for each of the synthesis target pixels based on a result of the determination.

It is to be understood that both the foregoing general description and the following detailed description of the disclosed technology are illustrative and explanatory and are intended to provide further explanation of the disclosed technology as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an image processing device based on some embodiments of the disclosed technology.

FIG. 2 is a flowchart illustrating an example of an image processing method based on some embodiments of the disclosed technology.

FIG. 3A is a diagram illustrating an example of the image processing method based on some embodiments of the disclosed technology.

FIG. 3B is a diagram illustrating an example of the image processing method based on some embodiments of the disclosed technology.

FIG. 4 is a flowchart illustrating an example of the image processing method based on some embodiments of the disclosed technology.

FIG. 5A is a diagram illustrating an example of the image processing method based on some embodiments of the disclosed technology.

FIG. 5B is a diagram illustrating an example of an image processing method according to a comparative example.

FIG. 5C is a diagram illustrating an example of the image processing method based on some embodiments of the disclosed technology.

FIG. 6 is a flowchart illustrating an example of the image processing method based on some embodiments of the disclosed technology.

FIG. 7 is a block diagram showing an example of a computing device corresponding to the image processing device of FIG. 1 based on some embodiments of the disclosed technology.

### DETAILED DESCRIPTION

This patent document provides implementations and examples of an image processing device and an image processing method that may be used in configurations to substantially address one or more technical or engineering issues and to mitigate limitations or disadvantages encountered in some other image processing devices. Some implementations of the disclosed technology relate to an image processing device that synthesizes a plurality of images in which flicker or a moving object is present. Some implementations of the disclosed technology relate to an image processing device that determines whether flicker or a moving object is present based on luminance values of pixels to be synthesized. Some implementations of the disclosed technology relate to an image processing device that adjusts weights used for image synthesis depending on the presence of flicker or a moving object. Some implementations of the disclosed technology relate to an image processing device that corrects a color of an image using a white balance coefficient before image synthesis in order to prevent color distortion of a composite image. In recognition of the issues above, the disclosed technology may provide an image processing device that synthesizes a plurality of images in which flicker or a moving object is present. The disclosed technology may provide an image processing device that determines whether flicker or a moving object is present based on luminance values of pixels to be synthesized. The disclosed technology may provide an image processing device that adjusts weights used for image synthesis depending on whether the presence of flicker or a moving object. The disclosed technology may provide an image processing device that corrects a color of an image using a white balance coefficient before image synthesis in order to prevent color distortion of a composite image.

Reference will now be made in detail to the embodiments of the disclosed technology, examples of which are illustrated in the accompanying drawings. Wherever possible, the same reference numbers will be used throughout the drawings to refer to the same or like parts. While the disclosed technology is susceptible to various modifications and alternative forms, specific embodiments thereof are shown by way of example in the drawings. However, the disclosed technology should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Hereinafter, some embodiments of the disclosed technology will be described in detail with reference to the accompanying drawings. However, the disclosed technology may be implemented in various forms and is not limited to the embodiments described herein.

In some embodiments of the disclosed technology, detailed descriptions of well-known functions and configurations are omitted when such details would obscure the subject matter of the disclosed technology. In the drawings, components unrelated to the disclosed technology are omitted for clarity, and similar reference numbers are used throughout the specification to refer to similar components.

In some embodiments of the disclosed technology, terms such as “first” and “second,” are used to distinguish one element from another and is not used to limit the elements. Unless otherwise specified, such terms do not imply any particular order or importance of elements. Accordingly, an element referred to as a “first” element in an embodiment may be referred to as a “second” element in another embodiment, and vice versa.

In some embodiments, components are distinguished from each other to clearly describe their characteristics, but this does not necessarily imply physical separation. That is, a plurality of components may be integrated into a single hardware or software module, and a single component may be divided into a plurality of hardware or software modules. Accordingly, both integrated and divided configurations are within the scope of the disclosed technology even if not specifically stated.

In some embodiments, components described with reference to various embodiments are not all necessarily required, and some components may be used selectively. Accordingly, embodiments comprising only a subset of the components described in one embodiment are also within the scope of the disclosed technology. Further, embodiments implemented by adding components to various embodiments are also within the scope of the disclosed technology.

In some embodiments of the disclosed technology, expressions of positional relationships such as “top,” “upper,” “bottom,” “lower,” “left,” “right,” and similar expressions are used for convenience of explanation. When the drawings illustrated in the present specification are viewed in reverse, the positional relationships described in the specification may be interpreted in the opposite manner.

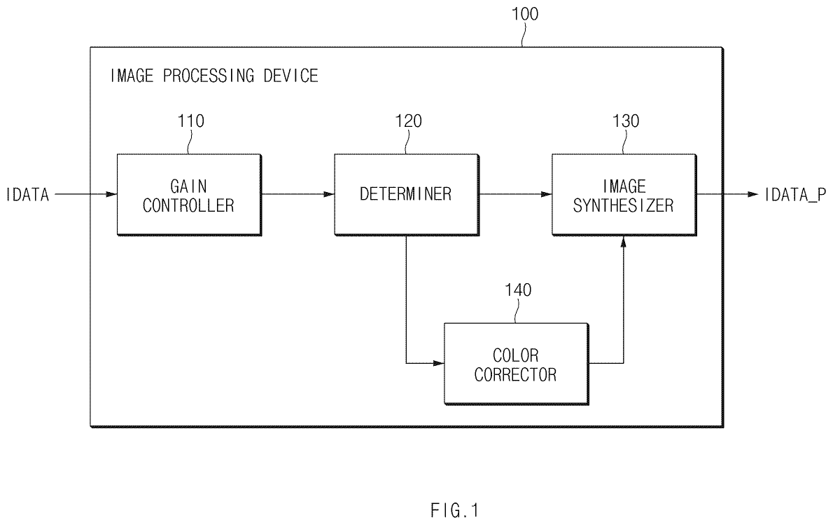

Hereinafter, example embodiments of the disclosed technology will be described in detail with reference to FIGS. 1 to 7.

FIG. 1 is a block diagram illustrating an example of an image processing device based on some embodiments of the disclosed technology.

Referring to FIG. 1, the image processing device 100 may perform at least one image signal process on image data (IDATA) for an image of a target object that is captured by an imaging device to generate the processed image data (IDATA_P).

The image processing device 100 may reduce noise in image data (IDATA), and may perform various kinds of image signal processing (e.g., demosaicing, defect pixel correction, gamma correction, color filter array interpolation, color matrix, color correction, color enhancement, lens distortion correction, etc.) for image-quality improvement of the image data. In addition, the image processing device 100 may compress image data that has been created by execution of image signal processing for image-quality improvement, such that the image processing device 100 can create an image file using the compressed image data. Alternatively, the image processing device 100 may recover image data from the image file. In this case, the scheme for compressing such image data may be a reversible format or an irreversible format. As a representative example of such compression format, in the case of using still images, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene or a target object, but the scope of the disclosed technology is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some implementations of the disclosed technology, it is assumed that the image data (IDATA) is generated by the image sensing device.

The pixel array may include a color filter array (CFA) in which color filters are arranged according to a predetermined pattern (e.g., a Bayer pattern, a quad-Bayer pattern, nona-Bayer pattern, an RGBW pattern, etc.) so that each color filter can sense light within a predetermined wavelength band. The pattern of the image data (IDATA) may be determined based on the type of the pattern of the CFA.

In some embodiments, the image processing device 100 may be mounted on a chip that is separate from the chip on which the image sensing device is mounted. The chip including the image sensing device and the chip including the image processing device 100 can communicate with each other through a predetermined interface. In one embodiment, the chip on which the image sensing device is mounted and the chip on which the image processing device 100 is mounted may be implemented in one package, for example, a multi-chip package (MCP), but the scope of the disclosed technology is not limited thereto.

The image processing device 100 may include a gain controller 110, a determiner 120, an image synthesizer 130, and/or a color corrector 140.

The gain controller 110 may control a gain to be applied to an input image. Specifically, the gain controller 110 may determine a gain based on an exposure time applied when the input image is captured, and may apply the gain to the input image. For example, the gain controller 110 may generate a first image by correcting a first input image using a first gain. In addition, the gain controller 110 may generate a second image by correcting a second input image using a second gain greater than the first gain. In this case, the first input image may be an image captured with a longer exposure time than the second input image. In other words, the first input image may be a brighter image than the second input image. Therefore, the second gain may have a greater value than the first gain. Specifically, when the exposure time of the input images is denoted by “T” (where the exposure time of the i-th input image is referred to as “Tᵢ”), a gain ratio of the i-th input image may be denoted by “max(T)/Ti”. In other words, the ratio of the gains may be determined as the inverse of the ratio of the exposure times. For example, assuming that the image processing device 100 performs image synthesis using a first input image captured during a first exposure time, a second input image captured during a second exposure time, and a third input image captured during a third exposure time, and assuming that the second exposure time is 0.25 times the first exposure time and the third exposure time is 0.5 times the first exposure time, a second gain applied to the second input image may be 4 times the first gain applied to the first input image, and the third gain applied to the third input image may be twice the first gain.

The image processing device 100 may apply a second gain to a second input image that is darker than the first input image when the first input image includes a signal of a saturated region due to a long exposure time, and may thus obtain a signal of a region brighter than the saturated region.

The determiner 120 may determine whether flicker or a moving object is present in the plurality of images by analyzing the plurality of images. Specifically, the determiner 120 may calculate a ratio of the number of pixels each having a luminance value lower than a threshold luminance value to the number of synthesis target pixels at the same position (e.g., pixels at the (i, j) coordinates of each of the plurality of images) in the plurality of images. The determiner 120 may then determine whether the calculated ratio is less than a threshold ratio, and, based on this, may determine whether a flicker or a motion of an object is present in the plurality of images. In some implementations, the flicker or the moving object may be causes of an image difference between a plurality of images. In some implementations, the term “flicker” may refer to unwanted temporal variations in image brightness or color caused by the interaction between the exposure time of the image sensor and the fluctuating light source.

In addition, the determiner 120 may determine that neither flicker nor moving objects is present if a difference between the largest pixel value and the smallest pixel value among the pixel values of the target pixels for synthesis is smaller than a threshold difference value. More specific details as to the operation of the determiner 120 will be described later.

The image synthesizer 130 may synthesize multiple images. Specifically, the image synthesizer 130 may vary the synthesis method depending on whether flicker or a moving object is detected. For example, to address flicker, it may be effective to prioritize images captured during an exposure time in which image distortion due to flicker is unlikely to occur. Accordingly, when the image synthesizer 130 determines that flicker has occurred, the image synthesizer 130 may synthesize multiple images by assigning the highest weight to the image captured during the longest exposure time among a plurality of weights respectively assigned to the plurality of images. For example, the image synthesizer 130 may perform image synthesis by assigning a weight of “1” to the image captured during the longest exposure time and assigning a weight of “0” to the other images.

In addition, to reduce image distortion in a region where a moving object is present in multiple images, it may be effective for the image synthesize 130 to prioritize images with short exposure times during the image synthesis. This is because images with short exposure times are less affected by subject motion or camera shake, may be relatively less affected by the moving object, and are less likely to be saturated in high-illuminance portions of the images. Therefore, when the image synthesizer 130 determines that the moving object has occurred, it may assign the highest weight to the image captured during the shortest exposure time among the multiple weights, and may synthesize the multiple images accordingly. For example, the image synthesizer 130 may perform image synthesis by setting the weight for the image captured during the shortest exposure time to “1” and setting the weights for the other images to zero “0,” although the disclosed technology is not limited thereto.

In addition, upon determining that neither flicker nor a moving object has occurred, the image synthesizer 130 may adjust the multiple weights corresponding to the multiple images based on the luminance value of any one of the multiple images, and may synthesize the multiple images using the adjusted weights. More specific details as to the method of synthesizing the images will be described later.

The color corrector 140 may prevent color distortion in the composite image by correcting the color of the image before image synthesis is performed. For example, the color corrector 140 may correct the color of the image by adjusting a red component value of the image using a white balance coefficient for a red component of the image, and adjusting a blue component value of the image using the white balance coefficient for a blue component of the image.

The white balance coefficient may be a coefficient that is used to correct differences in the color temperature of the image and allow the color of the image to be viewed naturally. More specific details as to the method of performing such color correction will be described later. In some implementations, the term “color temperature” can be used to indicate a numerical representation of the color of light.

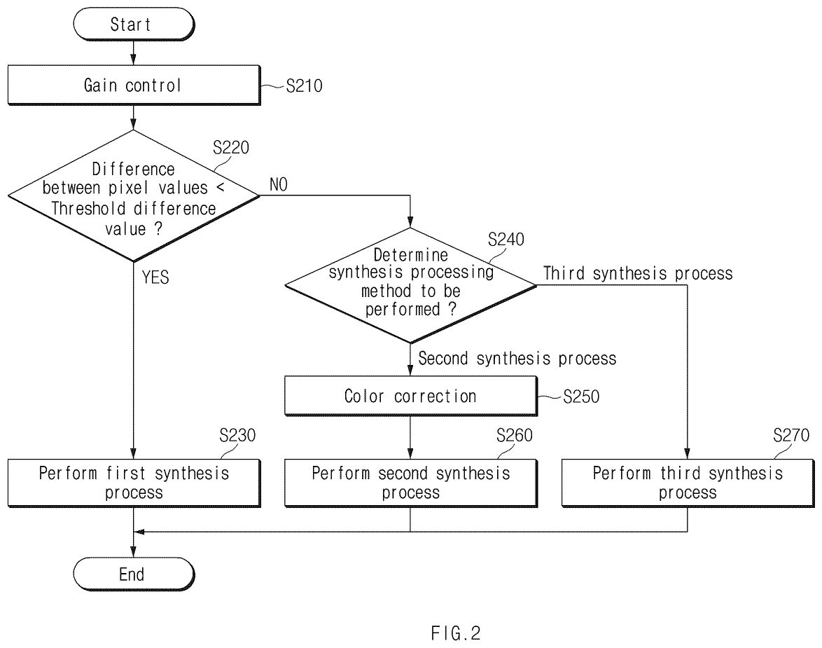

FIG. 2 is a flowchart illustrating an example of an image processing method based on some embodiments of the disclosed technology.

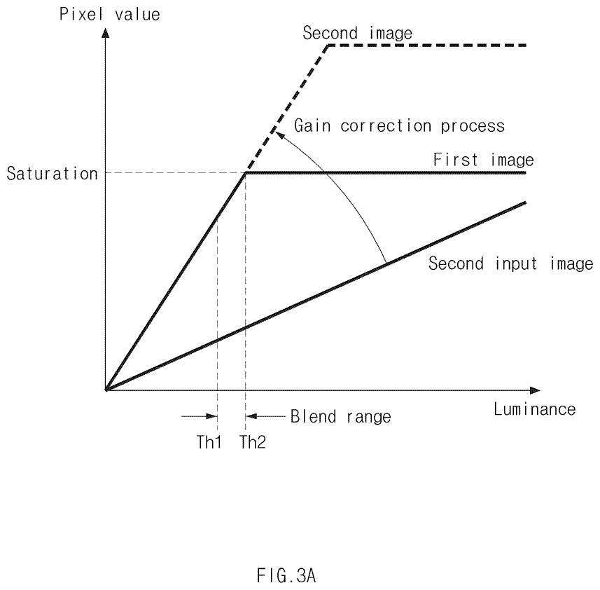

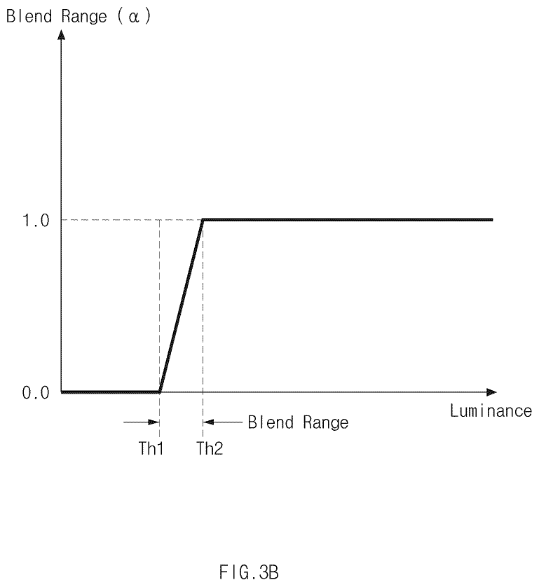

FIG. 3A is a diagram illustrating an example of the image processing method based on some embodiments of the disclosed technology.

FIG. 3B is a diagram illustrating an example of the image processing method based on some embodiments of the disclosed technology.

Hereinafter, the image processing method of FIG. 2 according to example embodiments of the disclosed technology will be described with reference to FIGS. 3A and 3B.

Referring to FIG. 2, the image processing method based on an example embodiment of the disclosed technology may perform gain control in operation S210. For example, the image processing method may apply a gain to an input image. Specifically, the image processing method may determine the gain based on the exposure time used when the input image is captured, and may apply the gain to the input image. The image processing method may correct a first input image captured during a first exposure time using a first gain, and may thus generate a first image accordingly. In addition, the image processing method may correct a second input image captured during a second exposure time using a second gain, and may thus generate a second image accordingly. In addition, the image processing method may correct a third input image captured during a third exposure time using a third gain, and may generate a third image accordingly. In this case, the first exposure time may be the longest, the second exposure time may be the shortest, and the third exposure time may be shorter than the first exposure time and longer than the second exposure time.

In operation S220, the image processing method may determine whether the difference between the largest pixel value and the smallest pixel value among pixel values of the synthesis target pixels located at the same position within multiple images is less than a threshold difference value. For example, when a pixel value of a pixel located at the (i, j) coordinates in the first image is referred to as “LEPᵢ”, and a pixel value of a pixel located at the (i, j) coordinates in the second image is referred to as “SEPᵢ”, the image processing method may determine whether the absolute value |LEPᵢ−SEPᵢ| is less than a threshold difference value (i.e., |LEPᵢ−SEPᵢ|<threshold difference value).

When the difference between the pixel values is less than the threshold difference value, the image processing method may perform a first synthesis process in operation S230. When the difference between the pixel values is less than the threshold difference value, it can be considered that neither flicker nor a moving object is present in the image, but the disclosed technology is not limited thereto.

The first synthesis process may refer to a process of synthesizing a plurality of images by adjusting a plurality of weights corresponding to the plurality of images based on a luminance value of any one image among the plurality of images. Referring to FIG. 3A, assuming that a first image and a second image, both gain-corrected images, are synthesized and the second image may have a pixel value greater than a saturation value due to gain application, a composite image may be generated by synthesizing the first image and the second image. Synthesis parameters may be used to generate a composite image through the first synthesis process. The synthesis parameters may be threshold values to be used in the first synthesis process. Specifically, the synthesis parameters may include a first threshold value (Th1) and a second threshold value (Th2) for luminance values. For example, when a luminance value of the pixel located at the (i, j) coordinates of the first image is less than the first threshold value (Th1), the pixel value of the pixel located at the (i, j) coordinates of the composite image may be a value of the pixel located at the (i, j) coordinates of the first image. The luminance value of the pixel located at the (i, j) coordinates of the first image may correspond to the pixel value of the pixel located at the (i, j) coordinates of the first image. For example, the luminance value of the pixel located at the (i, j) coordinates of the first image may be the pixel value of the pixel located at the (i, j) coordinates of the first image, without being limited thereto. In addition, when the luminance value of the pixel located at the (i, j) coordinates of the first image is equal to or greater than the first threshold value (Th1) and less than the second threshold value (Th2), the pixel value of the pixel located at the (i, j) coordinates of the composite image may be computed as: (1−α)×(value of the pixel at the (i, j) coordinates of the first image)+α×(value of the pixel at the (i, j) coordinates of the second image). When the luminance value of the pixel located at the (i, j) coordinates of the first image is equal to the second threshold value, the pixel value of the pixel may be equal to the pixel value in the saturated state. However, when gain correction is performed, a pixel value located at the luminance of the second threshold value may be equal to or greater than a pixel value of a pixel in the saturated state. In addition, when the luminance value of the pixel located at the (i, j) coordinates of the first image is equal to or greater than the second threshold value (Th2), the pixel value of the pixel located at the (i, j) coordinates of the composite image may be the value of the pixel located at the (i, j) coordinates of the second image. The above content can be briefly represented by Equation 1 below.

$$[ Equation 1 ]$$

$$Composite {Image}_{i , j} = \{ \begin{matrix}First {Image}_{i , j} , & Luminance < Th 1 \\ ( 1 - α ) \times First {Image}_{i , j} + α \times Second {Image}_{i , j} , & Th 1 \leq Luminance < Th 2 \\ Second {Image}_{i , j} , & Th 2 \leq Luminance\end{matrix}$$

In Equation 1, the composite image (i, j) may refer to the pixel value of the pixel located at the (i, j) coordinates of the composite image. In addition, the first image (i, j) may refer to the pixel value of the pixel located at the (i, j) coordinates of the first image. In addition, the second image (i, j) may refer to the pixel value of the pixel located at the (i, j) coordinates of the second image.

Unlike the above description, image synthesis may be performed based on the luminance value of the pixel located at the (i, j) coordinates of the second image. For example, when the luminance value of the pixel located at the (i, j) coordinates of the second image is less than the first threshold value (Th1), the pixel value of the pixel located at the (i, j) coordinates of the composite image may be a value of the pixel located at the (i, j) coordinates of the first image. The luminance value of the pixel located at the (i, j) coordinates of the second image may correspond to the pixel value of the pixel at the (i, j) coordinates of the second image. For example, the luminance value of the pixel located at the (i, j) coordinates of the second image may be a pixel value of the pixel located at the (i, j) coordinates of the second image, without being limited thereto. In addition, when the luminance value of the pixel located at the (i, j) coordinates of the second image is equal to or greater than the first threshold value (Th1) and less than the second threshold value (Th2), the pixel value of the pixel located at the (i, j) coordinates of the composite image may be computed as: (1−α)×(value of the pixel at the (i, j) coordinates of the first image)+α×(value of the pixel at the (i, j) coordinates of the second image). In addition, when the luminance value of the pixel located at the (i, j) coordinates of the second image is equal to or greater than the second threshold value (Th2), the pixel value of the pixel located at the (i, j) coordinates of the composite image may be the value of the pixel located at the (i, j) coordinates of the second image.

The first image and the second image may be synthesized at a predetermined ratio to generate a composite image. For example, as described above, the pixel value of the pixel located at the (i, j) coordinates of the composite image may be computed using the following expression” ((1−α)×First Image_{i,j}+α×Second Image_{i,j}). Referring to FIG. 3B, the a value may vary depending on the luminance value of the first image or the second image. Specifically, as the luminance value of the first image or the second image increases from the first threshold value (Th1) to the second threshold value (Th2), the a value may also linearly increase from 0 to 1, although the disclosed technology is not limited thereto.

The image processing method may determine the synthesis processing method to be performed in operation S240 when the difference in pixel values is greater than or equal to the threshold difference value. A second synthesis process (S260) may be a method of synthesizing multiple images by assigning the highest weight to the image captured during the longest exposure time among the multiple weights respectively assigned to the multiple images. For example, the image processing method may perform image synthesis by setting the weight for the first image to “1” and setting the weights for the other images to “0,” although the disclosed technology is not limited thereto.

A third synthesis process (S270) may be a method of synthesizing multiple images by assigning the highest weight to the image captured during the shortest exposure time among the multiple weights. For example, the image processing method may perform image synthesis by setting the weight for the second image to “1” and setting the weights for the other images to “0,” although the disclosed technology is not limited thereto.

Assuming that two images (e.g., the first image and the second image) are synthesized, the image processing method may set a synthesis mode value and may switch the synthesis processing method based on the synthesis mode value. For example, images captured by a surveillance camera may be synthesized through the second synthesis processing method, while images captured by a smartphone may be synthesized through the third synthesis processing method, and the synthesis processing method may be determined by receiving a mode value from a camera control program. However, the method of determining the synthesis processing method is not limited to the examples described above.

In addition, when the image processing method generates a composite image by synthesizing three or more images, the synthesis processing method may be determined based on the luminance values of the synthesis target pixels located at the same position in the synthesis target images. For example, in a situation where the first image, the second image, and the third image are synthesized, when the image processing method determines that luminance reduction has occurred in any one of the second image and the third image, the image processing method may determine that a flicker has occurred and perform image synthesis through the second synthesis processing method. In addition, when the image processing method determines that luminance reduction has occurred in the second image and the third image, the image processing method may determine that a moving object has occurred and perform image synthesis through the third synthesis processing method.

In addition, the image processing method may determine predetermined regions for the first image, the second image, and the third image, and may detect pixels in which luminance reduction has occurred among pixels included in the predetermined regions. In addition, the image processing method may determine which of the second image and the third image includes one or more pixels in which luminance reduction has occurred. In addition, the image processing method may determine whether a first image in which luminance reduction has occurred based on a first coordinate included in a predetermined region is different from a second image in which luminance reduction has occurred based on a second coordinate included in the predetermined region, and may determine whether flicker or a moving object has occurred in the corresponding predetermined region based on the determination result. When the first image in which luminance reduction has occurred based on the first coordinate included in the predetermined region is different from the second image in which luminance reduction has occurred based on the second coordinate included in the predetermined region, the image processing method may determine the corresponding predetermined region as a region in which the moving object has occurred. When the first image in which luminance reduction has occurred based on the first coordinate included in the predetermined region is equal to the second image in which luminance reduction has occurred based on the second coordinate included in the predetermined region, the image processing method may determine the corresponding predetermined region as a region in which the flicker has occurred, but the scope of the image processing method according to the example embodiment is not limited to what has been described above.

In addition, the image processing method may perform the second synthesis process when the ratio of the number of pixels having a luminance value lower than or equal to a threshold luminance value among the synthesis target pixels to the number of synthesis target pixels located at the same position in multiple images is less than a threshold ratio. In addition, the image processing method may perform the third synthesis process when the above-described ratio is greater than or equal to the threshold ratio. More specific details as to the third synthesis process will be described later.

In operation S250, the image processing method may perform color correction. Specifically, the image processing method may correct the color of the image before performing the second synthesis process, if necessary. More specific details on the color correction will be described later.

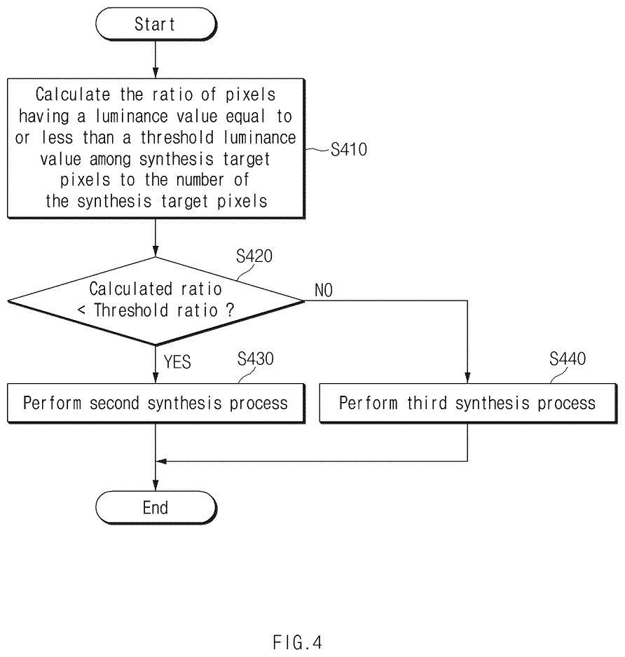

FIG. 4 is a flowchart illustrating an example of the image processing method based on some embodiments of the disclosed technology.

The image processing method may determine an image synthesis method, and may perform image synthesis using the determined method. Specifically, in operation S410, the image processing method may calculate a ratio of the number of pixels having a luminance value lower than or equal to a threshold luminance value among the synthesis target pixels to the number of the synthesis target pixels located at the same position in multiple images. For example, assuming that the first image, the second image, and the third image are synthesized, the number of pixels having a luminance value lower than or equal to a threshold luminance value among the synthesis target pixels located at the (i, j) coordinates of the first image, the second image, and the third image may be calculated, and the above-described ratio may be calculated using the calculated number of pixels.

The threshold luminance value may be determined based on the luminance value of the first image, which is an image captured during the longest exposure time among the plurality of images. For example, the image processing method may determine a predetermined region including a first synthesis target pixel (located at the (i, j) coordinates of the first image) within the first image, and may determine a threshold luminance value based on an average value of luminance values of pixels having the same color as the first synthesis target pixel within the predetermined region. For example, a value corresponding to 10% of the average luminance value of the pixels may be determined as the threshold luminance value, without being limited thereto.

If the number of pixels of the first image included in the predetermined region, the number of pixels of the second image in the predetermined region, and the number of pixels of the third image included in the predetermined region are different from each other, the image processing method may perform normalization so that the first image, the second image, and the third image have the same number of pixels. This is because a sensor that captures images with different exposure times can generate images having a different number of pixels depending on the exposure time.

In operation S420, the image processing method may determine whether the calculated threshold ratio is less than a threshold ratio. For example, assuming that the threshold ratio is 35%, the image processing method may determine whether the ratio of pixels each having a luminance value lower than the threshold luminance value among the pixels to be synthesized is less than 35%, without being limited thereto.

In operation S430, the image processing method may perform a second synthesis process if the calculated ratio is less than the threshold ratio. For example, the image processing method may determine that a flicker has occurred when the calculated ratio is less than the threshold ratio, and may perform the second synthesis process.

In operation S440, the image processing method may perform a third synthesis process if the calculated ratio is greater than or equal to the threshold ratio. For example, the image processing method may determine that a moving object has occurred when the calculated ratio is greater than or equal to the threshold ratio, and may perform the third synthesis process.

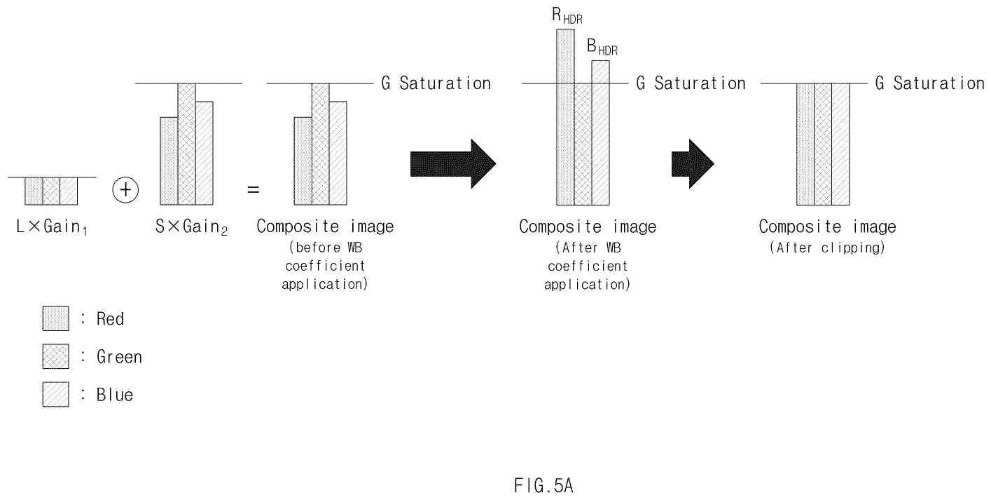

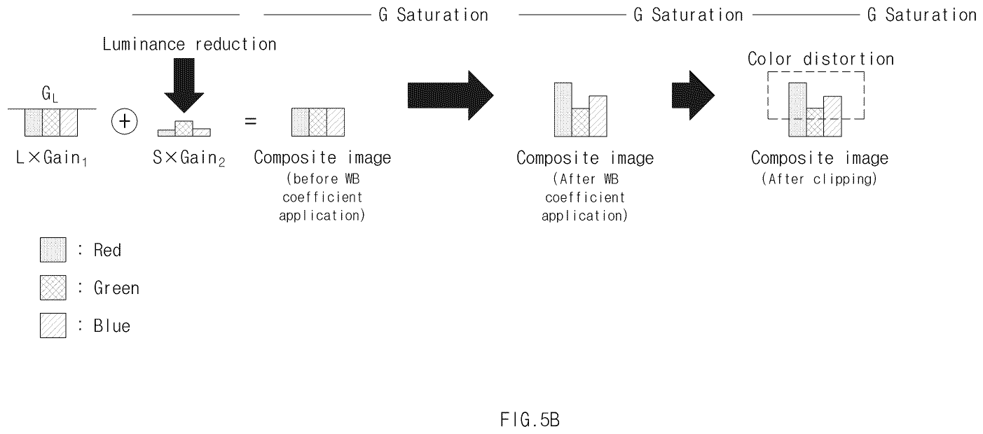

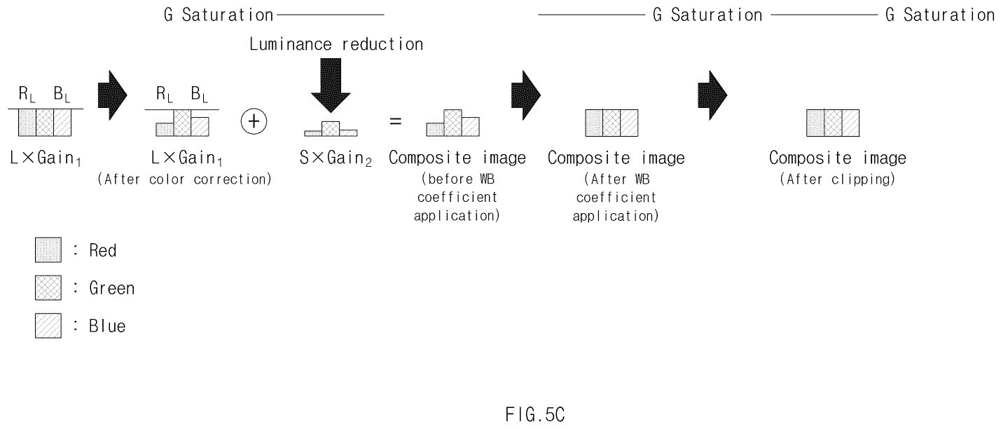

FIG. 5A is a diagram illustrating an example of the image processing method based on some embodiments of the disclosed technology.

Referring to FIG. 5A, the image processing method according to an example embodiment of the disclosed technology may apply a white balance coefficient (i.e., WB coefficient) to a composite image, and may perform clipping on the composite image to which the white balance coefficient is applied.

Assuming that a first image having a long exposure time and a second image having a short exposure time are synthesized, the process of applying the white balance coefficient may be represented by Equation 2 below.

$$\begin{matrix}{R}_{HDR} = ( ( {R}_{L} \times {Gain}_{1} ) ⊕ ( {R}_{S} \times {Gain}_{2} ) ) \times {WB}_{R} \\ {G}_{HDR} = ( {G}_{L} \times {Gain}_{1} ) ⊕ ( {G}_{S} \times {Gain}_{2} ) \\ {B}_{HDR} = ( ( {B}_{L} \times {Gain}_{1} ) ⊕ ( {B}_{S} \times {Gain}_{2} ) ) \times {WB}_{B}\end{matrix} \qquad [ Equation 2 ]$$

In Equation 2, R_{HDR}, G_{HDR}, and B_{HDR} are pixel values respectively corresponding to R, G, and B of the image to which the white balance coefficient is applied, R_{L}, G_{L}, and B_{L} are pixel values of the first image, R_{S}, G_{S}, and B_{S} are pixel values of the second image, Gain₁ is a first gain value applied to the first image, Gain₂ is a second gain value applied to the second image, WB_{R} is a first white balance coefficient, WB_{B} is a second white balance coefficient, and the symbol ⊕ indicates that two pixels are synthesized. The first white balance coefficient is a value used to correct the red component of images, and corresponds to the white balance coefficient associated with the red component. The second white balance coefficient is a value used to correct the blue component of images, and corresponds to the white balance coefficient associated with the blue component. When the first exposure time of the first image is four times the second exposure time of the second image, Gain₁ may be set to 1 (i.e., Gain₁=1) and Gain₂ may be set to 4 (i.e., Gain₂=4).

FIG. 5A illustrates a method of synthesizing images by giving priority to the second image, which is a short-exposure image. For example, a first weight for the first image may be set to “0,” and a second weight for the second image may be set to “1” to synthesize the first image and the second image. Accordingly, a composite image obtained by synthesizing the first image and the second image may be identical to the second image, although the disclosed technology is not limited thereto.

When the white balance coefficient is applied to a composite image, each of the pixel value of the R component and the pixel value of the B component of the composite image to which the white balance coefficient is applied may exceed a saturation value (G). As a result, image distortion may occur. To address this issue, the image processing method may perform clipping on the R component pixel value and the B component pixel value so that neither the R component pixel value nor the B component pixel value exceeds a predetermined value. For example, the image processing method may perform clipping on the R component pixel value and the B component pixel value so that neither the R component pixel value nor the B component pixel value exceeds the G saturation value, although the disclosed technology is not limited thereto. The image processing method may also store a separate table, and may adjust the R component pixel value and the B component pixel value by referring to the stored table.

FIG. 5B is a diagram illustrating an example of an image processing method according to a comparative example.

Referring to FIG. 5B, the image processing method according to the comparative example may synthesize a first image captured during a long exposure time and a second image captured during a short exposure time, may apply a white balance coefficient to the composite image, and may perform clipping on the composite image to which the white balance coefficient is applied.

Assuming that the luminance of the second image has decreased due to the occurrence of flicker or similar phenomena, and the image processing method sets the weight for the first image to “1” and the weight for the second image to “0.” to perform image synthesis using the set weights, each of the pixel values of the composite image may be less than the G saturation value. In this case, even if the white balance coefficient is applied to the composite image, pixel values in the composite image may remain below the G saturation value. Therefore, even if clipping is performed, the R component pixel value and the B component pixel value may remain unchanged. Since the R component pixel value and the G component pixel value of the composite image to which the white balance coefficient is applied have increased due to the application of the white balance coefficient, the color of the composite image after clipping may be distorted.

FIG. 5C is a diagram illustrating an example of the image processing method based on some embodiments of the disclosed technology.

Referring to FIG. 5C, the image processing method according to an example embodiment of the disclosed technology may perform color correction on a first image captured with a long exposure time, may synthesize the color-corrected first image and the second image captured with a short exposure time, may apply a white balance coefficient to the composite image, and may perform clipping on the composite image to which the white balance coefficient is applied.

The image processing method may perform color correction on the first image using white balance coefficients before image synthesis is performed. For example, the image processing method may correct a red component value (R_{L}) of the first image using a first white balance coefficient (WB_{R}), and may correct a blue component value (B_{L}) of the first image using a second white balance coefficient (WB_{B}). Through color correction, the red component value and the blue component value of the first image may be reduced as illustrated in FIG. 5C, although the disclosed technology is not limited thereto. More specific details as to the method of performing such color correction will be described later.

Assuming that luminance reduction occurs in the second image due to flicker or similar phenomena, and the image processing method sets the weight for the first image to “1” and the weight for the second image to “0” to perform image synthesis, each of the pixel values of the composite image may be less than the G saturation value. In this case, even if a white balance coefficient is applied to the composite image, pixel values in the composite image may remain below the G saturation value. Therefore, even if clipping is performed, the R component pixel value and the B component pixel value may remain unchanged. As the white balance coefficient is applied to the image, the red component values and the blue component values that have decreased in the color-corrected first image may be increased again. In this way, the image processing method based on some example embodiments of the disclosed technology can prevent color distortion.

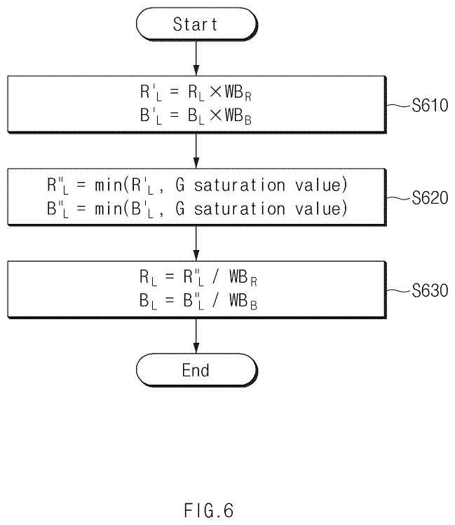

FIG. 6 is a flowchart illustrating an example of the image processing method based on some embodiments of the disclosed technology.

Referring to FIG. 6, the image processing method according to an example embodiment of the disclosed technology may perform color correction on an image before image synthesis is performed. For example, a first image captured with a long exposure time and a second image captured with a short exposure time may be synthesized, and the color of the first image may be corrected before image synthesis. The pixel value for the R components of the first image before color correction may be referred to as a first red component value (R_{L}), and the pixel value for the B components of the first image before color correction may be referred to as a first blue component value (B_{L}). In operation S610, the image processing method may generate a second red component value (R_{L}′) and a second blue component value (B_{L}′) by multiplying the first red component value (R_{L}) and the first blue component value (B_{L}) by the white balance coefficients (WB_{R}, WB_{B}), respectively.

In operation S620, the image processing method may determine a smaller first value (R_{L}″) from among the second red component value (R_{L}′) and the G saturation value, and may determine a smaller second value (B_{L}″) from among the second blue component value (B_{L}′) and the G saturation value.

In operation S630, the image processing method may generate a third red component value by dividing the first value (R_{L}″) by the first white balance coefficient (WB_{R}), and may correct the red color of the first image by replacing the first red component value (R_{L}) of the first image with the third red component value. In addition, the image processing method may generate a third blue component value by dividing the second value (B_{L}″) by the second white balance coefficient (WB_{B}), and may correct the blue color of the first image by replacing the first blue component value (B_{L}) of the first image with the third blue component value.

The white balance coefficient used for color correction may use a value related to development, or values corresponding to a reference color temperature (e.g., D65) may be used in advance, without being limited thereto.

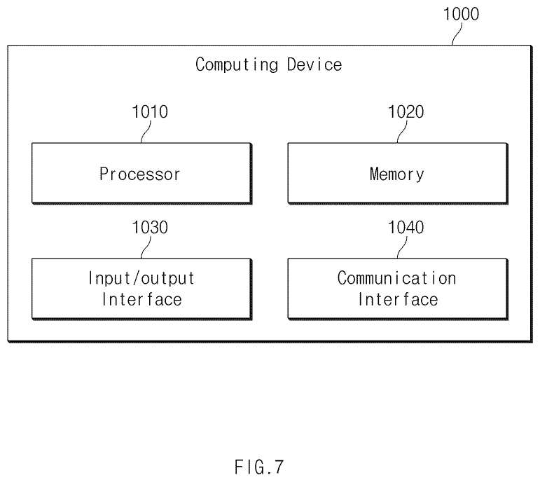

FIG. 7 is a block diagram showing an example of a computing device 1000 corresponding to the image processing device 100 of FIG. 1.

Referring to FIG. 7, the computing device 1000 may represent an embodiment of a hardware configuration for performing the operation of the image processing device 100 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the disclosed technology is not limited thereto.

Additionally, the internal configuration or arrangement of the computing device 1000 and the image sensing device may vary depending on the embodiment. For example, at least a portion of the image sensing device may be integrated into the computing device 1000. Alternatively, at least a portion of the computing device 1000 may be integrated into the image sensing device. In this case, at least a portion of the computing device 1000 may be mounted on a chip on which the image sensing device is mounted.

The computing device 1000 may include a processor 1010, a memory 1020, an input/output (I/O) interface 1030, and a communication interface 1040.

The processor 1010 may process data and/or instructions required to perform the operations of the components of the image processing device 100 described in FIG. 1. That is, the processor 1010 may refer to the image processing device 100, but the scope of the disclosed technology is not limited thereto.

The memory 1020 may store data and/or instructions required to perform operations of the components of the image processing device 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM)), EEPROM (Electrically Erasable PROM), flash memory, etc.).

That is, a computer program for performing the operations of the image processing device 100 disclosed in this document is recorded in the memory 1020 and executed and processed by the processor 1010, thereby implementing the operations of the image processing device 100.

The input/output (I/O) interface 1030 serves as an interface that connects an external input device (e.g., keyboard, mouse, touch panel, etc.) and/or an external output device (e.g., display) to the processor 1010, enabling data transmission and reception.

The communication interface 1040 is a component that can transmit and receive various types of data with an external device (e.g., an application processor, external memory, etc.), and may support wired or wireless communication.

As is apparent from the above description, the image processing device based on some embodiments of the disclosed technology may synthesize a plurality of images in which flicker or a moving object is present.

The image processing device based on some embodiments of the disclosed technology may determine whether flicker or a moving object occurs based on luminance values of pixels to be synthesized.

The image processing device based on some embodiments of the disclosed technology may adjust weights used for image synthesis depending on whether flicker or a moving object occurs.

The image processing device based on some embodiments of the disclosed technology may correct a color of an image using a white balance coefficient before image synthesis, and may thus prevent color distortion of a composite image.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image processing device comprising:
a determiner configured to detect an image difference between a plurality of images of a scene including a first image captured during a first exposure time and a second image captured during a second exposure time shorter than the first exposure time, wherein the image difference is related to various factors including occurrence of a flicker or motion of an object in the scene; and
an image synthesizer configured to:
upon determining that the image difference corresponds to the flicker, synthesize the plurality of images by assigning a highest weight to the first image among a plurality of weights respectively assigned to the plurality of images; and
upon determining that the image difference corresponds to the motion of the object, synthesize the plurality of images by assigning the highest weight to the second image among the plurality of weights respectively assigned to the plurality of images.

2. The image processing device according to claim 1, wherein the determiner is configured to:
determine that the image difference corresponds to the flicker, in response to determining that a ratio of a number of pixels each having a luminance value equal to or less than a threshold luminance value among synthesis target pixels to the number of the synthesis target pixels located at a same position within the plurality of images is less than a threshold ratio; and
determine that the image difference corresponds to the motion of the object, in response to determining that the ratio is greater than or equal to the threshold ratio.

3. The image processing device according to claim 2, wherein the determiner is configured to:
determine the threshold luminance value based on an average value of luminance values of pixels that have a same color as a first synthesis target pixel in a predetermined region including the first synthesis target pixel within the first image.

4. The image processing device according to claim 1, wherein the plurality of images includes:
a third image captured during a third exposure time that is shorter than the first exposure time and longer than the second exposure time,
wherein the determiner determines that the image difference corresponds to the flicker upon determining that luminance reduction has occurred in at least one of the second image and the third image.

5. The image processing device according to claim 1, wherein the plurality of images includes:
a third image captured during a third exposure time that is shorter than the first exposure time and longer than the second exposure time,
wherein the determiner determines that the image difference corresponds to the motion of the object upon determining that luminance reduction has occurred in the second image and the third image.

6. The image processing device according to claim 1, further comprising:
a color corrector configured to correct a color of the first image by:
correcting a first red component value of the first image using a first white balance coefficient; and
correcting a first blue component value of the first image using a second white balance coefficient.

7. The image processing device according to claim 6, wherein the color corrector is configured to correct a color of the first image by:
generating a second red component value by multiplying the first red component value by the first white balance coefficient;
generating a third red component value by dividing a smaller first value between the second red component value and a green component saturation value by the first white balance coefficient;
replacing the first red component value of the first image with the third red component value;
generating a second blue component value by multiplying the first blue component value by the second white balance coefficient;
generating a third blue component value by dividing a smaller second value between the second blue component value and the green component saturation value by the second white balance coefficient; and
replacing the first blue component value of the first image with the third blue component value.

8. The image processing device according to claim 6, wherein:
the color corrector is configured to correct the color of the first image to generate a color-corrected first image, upon determining that the image difference corresponds to the flicker; and
the image synthesizer is configured to synthesize the plurality of images using the color-corrected first image.

9. The image processing device according to claim 1, wherein the determiner is configured to:
determine that neither the flicker nor the motion of the object has occurred in response to determining that a difference between a largest pixel value and a smallest pixel value among pixel values of synthesis target pixels located at a same position in the plurality of images is less than a threshold difference value.

10. The image processing device according to claim 1, wherein the image synthesizer is configured to:
synthesize the plurality of images by adjusting the plurality of weights according to a luminance value of any one of the plurality of images upon determining that neither the flicker nor the motion of the object has occurred.

11. The image processing device according to claim 10, wherein the image synthesizer is configured to:
generate a composite image by using a pixel value of a first pixel when a luminance value of the first pixel of the first image is less than a first threshold luminance value;
generate a composite image by combining, at a predetermined ratio, (i) a pixel value of a second pixel located at a same position as the first pixel in the second image and (ii) the pixel value of the first pixel, in response to the luminance value of the first pixel being equal to or greater than the first threshold luminance value and less than a second threshold luminance value; and
generate the composite image using the pixel value of the second pixel in response to the luminance value of the first pixel being equal to or greater than the second threshold luminance value.

12. The image processing device according to claim 11, wherein:
the predetermined ratio linearly changes as the luminance value of the first pixel increases from the first threshold luminance value to the second threshold luminance value.

13. The image processing device according to claim 1, further comprising:
a gain controller configured to:
generate the first image by correcting a first input image using a first gain; and
generate the second image by correcting a second input image using a second gain greater than the first gain.

14. The image processing device according to claim 13, wherein the gain controller is configured to:
determine a ratio of the first gain to the second gain as an inverse of a ratio of the first exposure time to the second exposure time.

15. An image processing device comprising:
a determiner configured to determine whether a ratio of a number of pixels having a luminance value less than or equal to a threshold luminance value among synthesis target pixels to the number of the synthesis target pixels located at a same position in a plurality of images is less than a threshold ratio; and
an image synthesizer configured to perform image synthesis by adjusting a plurality of weights for each of the synthesis target pixels based on a result of the determination.

16. The image processing device according to claim 15, wherein:
the plurality of images includes a first image captured during a longest exposure time among the plurality of images; and
the image synthesizer is configured to perform image synthesis by assigning a highest weight to the first image among the plurality of weights respectively assigned to the plurality of images in response to the ratio being less than the threshold ratio.

17. The image processing device according to claim 15, wherein:
the plurality of images includes a second image captured during a shortest exposure time among the plurality of images; and
the image synthesizer is configured to perform image synthesis by assigning a highest weight to the second image among the plurality of weights respectively assigned to the plurality of images in response to the ratio being greater than or equal to the threshold ratio.

18. The image processing device according to claim 15, wherein:
the plurality of images includes a first image captured during a longest exposure time among the plurality of images; and
the image processing device further comprises:
a color corrector configured to correct a color of the first image by:
correcting a first red component value of the first image using a first white balance coefficient; and
correcting a first blue component value of the first image using a second white balance coefficient.

19. The image processing device according to claim 18, wherein the color corrector is configured to correct a color of the first image by:
generating a second red component value by multiplying the first red component value by the first white balance coefficient, generating a third red component value by dividing a smaller first value between the second red component value and a green component saturation value by the first white balance coefficient, and replacing the first red component value of the first image with the third red component value; and
generating a second blue component value by multiplying the first blue component value by the second white balance coefficient, generating a third blue component value by dividing a smaller second value between the second blue component value and the green component saturation value by the second white balance coefficient, and replacing the first blue component value of the first image with the third blue component value.

20. An image processing method comprising:
determining whether there is an image difference between a plurality of images of a scene based on luminance values of synthesis target pixels located at a same position in the plurality of images, wherein the image difference includes at least one of an image difference corresponding to flicker or an image difference corresponding to a motion of an object of the scene; and
performing image synthesis by adjusting a plurality of weights for each of the synthesis target pixels based on a result of the determination.
